(19) United States
(12) Patent Application Publication
(10) Pub. No.: US 2008/0187061 A1
(43) Pub. Date: Aug. 7, 2008

(54) SYSTEMS AND METHODS FOR RECONSTRUCTING STEERING MATRICES IN A MIMO-OFDM SYSTEM

(75) Inventors: Tarkesh PANDE, Dallas, TX (US); Srinath HOSUR, Plano, TX (US); Anuj BATRA, Dallas, TX (US); Deric W. WATERS, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/024,064

(22) Filed: Jan. 31, 2008

Related U.S. Application Data
(60) Provisional application No. 60/888,608, filed on Feb. 7, 2007.

(51) Int. Cl. H04L 27/28

(52) U.S. Cl. 375/260

(57) ABSTRACT

Embodiments provide a system and method for reconstructing steering matrices in a MIMO-OFDM (multiple-input multiple-output orthogonal frequency division multiplexing) system by interpolating steering matrices in transmit beamforming. The reconstructed steering matrices provide a faithful representation to the actual steering matrices. Embodiments receive channel information for a subset of sub-carriers of a channel, interpolate the channel information for the subset of sub-carriers to obtain at least one Givens rotation angle for remaining sub-carriers of the channel which are not members of the subset, and reconstruct missing steering matrices from the interpolated angles.

### CROSS-REFERENCE TO RELATED APPLICATION

The present application claims priority to U.S. provisional patent application Ser. No. 60/888,608, filed Feb. 7, 2007, and entitled “Givens Rotation Interpolation for Reconstructing Steering Matrices in a MIMO-OFDM System”, hereby incorporated herein by reference.

### BACKGROUND

As consumer demand for high data rate applications, such as streaming video, expands, technology providers are forced to adopt new technologies to provide the necessary bandwidth. Multiple Input Multiple Output (“MIMO”) is an advanced radio system that employs multiple transmit antennas and multiple receive antennas to simultaneously transmit multiple parallel data streams. Relative to previous wireless technologies, MIMO enables substantial gains in both system capacity and transmission reliability without requiring an increase in frequency resources.

MIMO systems exploit differences in the paths between transmit and receive antennas to increase data throughput and diversity. As the number of transmit and receive antennas is increased, the capacity of a MIMO channel increases linearly, and the probability of all sub-channels between the transmitter and receiver simultaneously fading decreases exponentially. As might be expected, however, there is a price associated with realization of these benefits. Recovery of transmitted information in a MIMO system becomes increasingly complex with the addition of transmit antennas. This becomes particularly true in MIMO orthogonal frequency-division multiplexing (OFDM) systems. Such systems employ a digital multi-carrier modulation scheme using numerous orthogonal sub-carriers.

Improvements are desired to achieve a favorable performance-complexity trade-off compared to existing MIMO detectors.

### BRIEF DESCRIPTION OF THE DRAWINGS

For a detailed description of exemplary embodiments of the invention, reference will be made to the accompanying drawings in which:

FIG. 1 illustrates an example multiple-input multiple-output orthogonal frequency-division multiplexing (MIMO-ODFM) system in which embodiments may be used to advantage;

FIG. 2 illustrates a flowchart of an interpolation method, according to embodiments; and

FIG. 3 illustrates an illustration of an interpolation process, according to embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In light of the foregoing background, embodiments enable improved multiple-input multiple-output (MIMO) detection by providing systems and methods for reconstructing missing steering matrices by interpolating known steering matrices in transmit beamforming for a MIMO-OFDM (multiple-input multiple-output orthogonal frequency divisional multiplexing) system. The steering matrices which are reconstructed provide a faithful representation to the actual steering matrices. Embodiments can work with different interpolation techniques such as, but not limited to, polynomial interpolation and spline interpolation. Further, although embodiments will be described for the sake of simplicity with respect to wireless communication systems, it should be appreciated that embodiments are not so limited, and can be employed in a variety of communication systems.

To better understand embodiments of this disclosure, it should be appreciated that in a MIMO-OFDM system, the received signal for every sub-carrier can be modeled by

rᵢ=Hᵢaᵢ+nᵢ i=1 . . . N_{sub}

where Hᵢ is the Nᵣₓ×Nₜₓ channel matrix for the i^{th} sub-carrier, aᵢ is the transmitted data vector, nᵢ is additive white Gaussian noise and N_{sub} denotes the number of sub-carriers.

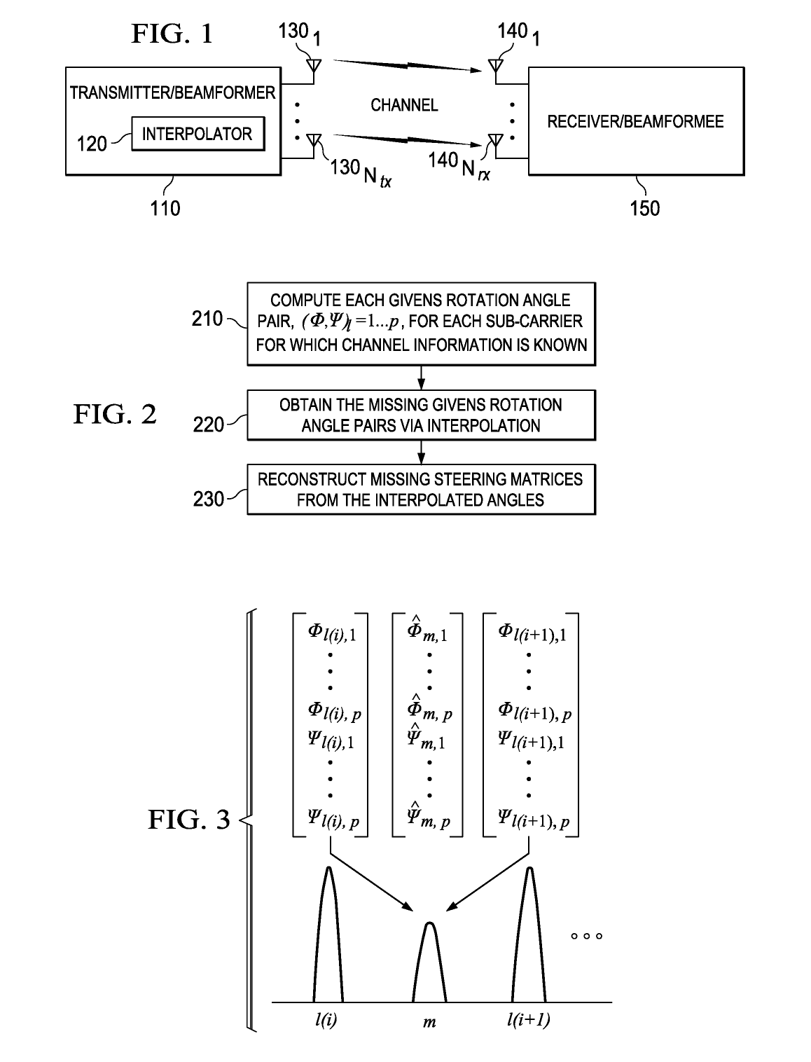

FIG. 1 depicts a MIMO-OFDM system which has the capability of adapting the signal to be transmitted to the channel by beamforming, in which embodiments may be used to advantage. As this system is a MIMO system, there are multiple transmitting antennas 130₁, . . . ,130_{N}_{ₜₓ}, where Nₜₓ is the number of transmitting antennas, and there are multiple receiving antennas 140₁, . . . ,140_{N}_{ᵣₓ}, where Nᵣₓ is the number of receiving antennas.

Embodiments of transmitter/beamformer 110 either computes or receives from beamformee 150 the steering matrices for all of the sub-carriers of the channel shared by beamformer 110 and receiver/beamformee 150. If transmitter or beamformer 110 has channel knowledge it may transmit on the dominant modes of the channel for each sub-carrier in order to improve error performance; see for example, A. Scaglione, P. Stoica, S. Barbarossa, G. B. Giannakis and H. Sampath, “Optimal designs for space-time linear precoders and decoders,” IEEE Transactions on Signal Processing, Vol., 50, pp. 1051-1064, May 2002. This communications methodology, otherwise known as beamforming, involves pre-multiplying the data vector aᵢ with a steering matrix Qₛ. Channel knowledge at beamformer 110 is typically derived based on information received from receiver or beamformee 150.

In general, beamforming should not increase the transmit power of the MIMO system. As a result, the steering matrix Qₛ is constrained to be a nearly orthonormal complex Nₜₓ×Nₛₜₛ matrix when beamforming Nₛₜₛ space-time streams over Nₜₓ transmit antennas (Nₜₓ≧Nₛₜₛ). The optimal steering matrix generally corresponds to the right singular vectors of the channel matrix Hᵢ which can be determined from the singular value decomposition (SVD):

Hᵢ=UᵢΣᵢVᵢ*; Q_{i,s}=V_{i,1:N}_{ₛₜₛ} i=1 . . . N_{sub}

where V_{i,1:N}_{ₛₜₛ} denotes the first Nₛₜₛ columns of the matrix Vᵢ, and Q_{i,s} is the corresponding steering matrix.

In practice, there are different ways a beamformer obtains the steering matrices for at least one of the sub-carriers. As an example, in the IEEE 802.11n wireless LAN standard (one example of a MIMO-OFDM system) there are three different methods of beamforming; see IEEE P802.11 Draft Amendment to Standard for Information Technology—Telecommunications and Information Exchange Between Systems—Local and Metropolitan Networks—Specific Requirements—Part 11: Wireless LAN Medium Access Control (MAC) and Physical Layer (PHY) Specifications: Enhancements for Higher Throughput, prepared by the 802.11 Working Group of the 802 Committee.
1. Implicit Beamforming. Beamformer 110 forms the channel estimates for the forward link via cooperation with beamformee 150; this cooperation assumes channel reciprocity between transmitter 110 and receiver 150. Beamformer 110 may perform a separate SVD on the channel matrices for each of the sub-carriers, or just a subset of the sub-carriers, to obtain the corresponding steering matrices.
2. Explicit Beamforming. Beamformee 150 measures the channel, and sends quantized steering matrix information to beamformer 110. There are two types of steering matrix feedback a beamformee can send with respect to explicit beamforming:
   a) Uncompressed steering matrix feedback: Each entry of the steering matrix is uniformly quantized and fed back to beamformer 110.
   b) Compressed steering matrix feedback: Beamformee 150 first parameterizes the steering matrix by angle pairs (Φ, Ψ)_{i=1 . . . p} obtained using Givens rotations; see for example, and not by way of limitation, H. Golub and C. F. Van Loan, Matrix Computations, Baltimore: Johns Hopkins University press, third ed., 1996. The number of angle pairs, p, depends on the dimensions of the steering matrix. As an example, and not by way of limitation, if:
      Nₜₓ=Nₛₜₛ=3 p=3,
      Nₜₓ=Nₛₜₛ=5 p=10,
      Nₜₓ=3, Nₛₜₛ=1 p=2,
      Nₜₓ=5, Nₛₜₛ=1 p=4.
   These angle pairs are quantized and fed back to beamformer 110, which in turn reconstructs the steering matrices from this angular information via Givens rotation matrices.
3. Full-CSI Feedback Beamforming. Beamformee 150 measures the channels and sends beamformer 110 the quantized channel gains for each transmit/receive antenna link. Beamformer 110 then performs an SVD on the quantized channel matrices to get the corresponding steering matrices.

Ideally, the steering matrices are computed and known by a beamformer for all of the sub-carriers; however, performance constraints normally dictate that fewer than all steering matrices for all of the sub-carriers are provided to a beamformer. An example of a performance constraint is the limited number of feedbacks that can be transmitted to the beamformer in order to minimize overhead. Thus, in order to further reduce the amount of feedback, regardless of the beamforming method employed, it frequently happens that beamformer 110 only has steering matrix information for a subset of the sub-carriers of size N<N_{sub}. Let L(N)= [symbol] l(1), . . . , l(N) [symbol] denote the ordered set of indices indicating the sub-carrier locations whose steering matrix information is fed back. In general, there is no restriction on the inter-sub-carrier spacing i.e., it may be non-uniform (l(i+1)−l(i)≠l(i+2)−l(i+1)). However, existing systems, for example and not by way of limitation, such as 802.11n, only enable feedback to beamformer 110 of information concerning either every second or every fourth sub-carrier. Thus, while beamformer 110 can determine the steering matrices of such subsets of sub-carriers, the steering matrices of the remaining sub-carriers remains unknown. In other words, regardless of the beamforming method employed, if the steering matrix information made available to beamformer 110 is only for a subset of sub-carriers of size N<N_{sub}, then beamformer 110 must somehow define the steering matrices to be used for the remaining sub-carriers, i.e., the remaining sub-carriers that are shared between transmitting antennas 130 and receiving antennas 140 which are not in this subset.

To accomplish this, embodiments obtain the missing Givens rotation angle pairs via interpolation and use the obtained rotation angle pairs to reconstruct the missing steering matrices. Specifically, and as illustrated in FIG. 2, if the channel information obtained by beamformer 110 is not already given in terms of Givens rotation angle pairs (Φ, Ψ)_{i=1 . . . p}, then embodiments first compute each pair (Φ, Ψ)_{i=1 . . . p} for each sub-carrier for which channel information is known (function 210). Let

$${\underline{θ}}_{k} = {[ {φ}_{k}^{T} , {\underline{ψ}}_{k}^{T} ]}^{T} \\ where {\underline{φ}}_{k} = {[ {φ}_{k , 1} , … , {φ}_{k , p} ]}^{T} {\underline{ψ}}_{k} = {[ {ψ}_{k , 1} , … , {ψ}_{k , p} ]}^{T} \qquad ( 1 )$$

denote the vector of parameterizing Givens rotation angle pairs for the k^{th} subcarrier and let

S(L(N))= [symbol] θₗ₍₁₎,θₗ₍₂₎, . . . , θ_{l(N)} [symbol] l(i)<l(i+1) (2)

denote the set of parameterizing angles for a subset of N sub-carriers. In the explicit beamforming with compressed steering matrix feedback scenario, quantized S(L(N)) is precisely the channel information that beamformee 150 sends back to beamformer 110. It should be appreciated, at this point, that no restriction has been placed on the spacing between sub-carriers for which steering matrix information is known i.e., it may be non-uniform (l(i+1)−l(i)≠l(i+2)−l(i+1)). However, knowledge of the sub-carrier spacing is useful in the interpolation process. A discussion on how the set of sub-carriers L(N) is chosen for feedback is provided later. It should also be understood that the matrix S(L(N)) with θₖ=[φₖ^{T},ψₖ^{T}]^{T} is not the only way of representing the parameterized Givens rotation angles as input to the interpolator. Some alternate examples, and not by way of limitation, are: θₖ=[exp(φₖ^{T}),ψₖ^{T}]^{T}, θₖ=[exp(φₖ^{T}), exp(ψₖ^{T})]^{T} and θₖ=[exp(φₖ^{T}), Trig(ψₖ^{T})]^{T} where Trig refers to any appropriate trigonometric function of choice.

Interpolator 120 of beamformer 110 obtains the missing Givens rotation angle pairs via interpolation (function 220) for the m^{th} sub-carrier by performing:

θ_{m,interp}=ƒ(S(L(N)),m) (3)

where ƒ(•) is an appropriate interpolation function. Some examples of interpolation functions that may be used by embodiments include, but are not limited to, linear functions, polynomial functions, rational functions, spline-based functions or trigonometric interpolation functions. As the interpolation is done on a vector space, the interpolation itself is relatively easy and, as is readily apparent after considering the teachings of the present disclosure, a great variety of interpolation functions may be used as desired; see for example, R. J. Y. Macleod, M. L. Baart, Geometry and Interpolation of Curves and Surfaces, Cambridge University Press 1998, or M. Schatzman, Numerical Analysis: A Mathematical Introduction, Clarendon Press, Oxford 2002.

It should be appreciated that, although interpolator 120 is illustrated as part of beamformer 110, that the location of interpolator 120 could be otherwise, e.g., separate from both beamformer 110 and beamformee 150, etc. It should be understood that operations carried out by interpolator 120 can alternatively be performed in software or by an application-specific integrated circuit (ASIC). Moreover, in some embodiments, the interpolation function might be a linear filter. The filter span and the type would be changed based on the specific channel encountered. For example, if the channel encountered does not vary rapidly from sub-carrier to sub-carrier, a linear interpolation over neighboring pairs of angles may be sufficient. Linear interpolation may be defined as

$${\underline{θ}}_{m , interp} = ( 1 - α ) {\underline{θ}}_{l ( i )} + α {\underline{θ}}_{l ( i + 1 )} ; \\ α = \frac{m - l ( i )}{l ( i + 1 ) - l ( i )} ; l ( i ) < m < l ( i + 1 ) \qquad ( 4 )$$

FIG. 3 gives a pictorial representation of such an embodiment. If, however, the channel demonstrates a high degree of frequency selectivity, an interpolation function such as a higher-order polynomial function, rational function or spline-based function would be more effective. In some embodiments, the system might employ a channel classifier, see for example, and not limitation, “System and Method for an Efficient Channel Classifier”, patent application Ser. No. ______, concurrently filed herewith, hereby incorporated fully herein by reference, to guide the selection of an appropriate interpolation function based on the channel type and sub-carrier spacing. Beamformer 110 then reconstructs the missing steering matrices from the interpolated angles (function 230).

Selection of the sub-carriers for which steering matrix information is to be fed back to beamformer 110 and the location of the selected sub-carriers is typically made by beamformee 150. One approach to achieve improved efficiency is to choose the fewest number of sub-carriers, and their locations, such that the error (quantified by a cost function C(L(N)) between the interpolated angles and the actual angles for all sub-carriers is less than a predefined threshold. Typical cost functions involve computing different norms of the error vector between the true value θ_{m,true} and the interpolated estimate θ_{m,interp}. In such embodiments, the decision rule for determining a minimum number of sub-carriers (N*) and their locations (L(N*)) can be computed as follows:

| | |
|---|---|
| For | N = 2, . . . , N_{sub} |
| | For each L(N) |

| $C ( L ( N ) ) = {{\sum }_{i = 1}^{{N}_{sub}}}_{i ∉ L ( N )} {‖ {θ}_{i , true} - f ( S ( L ( N ) ) , i ) ‖}_{p}$ | |
|---|---|
| if | C(L(N)) < threshold |
| | N* = N |
| | L(N*) = L(N) |
| | return |

end

end

end

where ∥·∥ₚ refers to the p^{th} norm. The spacing information selected by beamformee 150 can be sent by the beamformee along with the other channel information. In some embodiments, the beamformer/beamformee classifies the channel type using an appropriate classifier, see for example and not by way of limitation, “System and Method for an Efficient Channel Classifier”, (supra). Regardless of how the channel type is ascertained, an appropriate L(N) is selected from a predefined look-up table based on the channel type. In such embodiments, beamformee 150 preferably only sends the index from the predefined look-up table to beamformer 110. Beamformer 110 then uses the index to look-up the corresponding sub-carrier spacing information to use to compute each angle pair for each sub-carrier for which channel information is known, interpolates the missing Givens rotation angle pairs, and reconstructs the missing steering matrices from the interpolated angles.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A multiple-input multiple-output orthogonal frequency division multiplexing system, comprising:
a beamformer for receiving channel information for a subset of sub-carriers of a channel, interpolating the channel information that includes sub-carrier spacing information for the subset of sub-carriers to obtain at least one Givens rotation angle for remaining sub-carriers which are not members of the subset, and reconstructing missing steering matrices from the interpolated angles.

2. The system of claim 1, further comprising an interpolator for interpolating the channel information to obtain at least one Givens rotation angle.

3. The system of claim 2, wherein the interpolator is a linear filter.

4. The system of claim 2, wherein the beamformer comprises the interpolator.

5. The system of claim 2, wherein the interpolator applies at least one of the functions from the group of: a polynomial function, a rational function, a spline-based function and a trigonometric interpolation function.

6. The system of claim 1, wherein the channel information comprises Givens rotation angles for the subset of sub-carriers.

7. The system of claim 1, wherein the channel information comprises steering matrices of the subset of sub-carriers.

8. The system of claim 1, wherein the channel information comprises an index that enables the beamformer to obtain corresponding sub-carrier spacing information from a look-up table to be used to compute at least one angle pair for at least one sub-carrier of the subset.

9. The system of claim 1, further comprises a beamformee that determines the subset of sub-carriers based on a cost function.

10. The system of claim 1, further comprises a beamformee that transmits the sub-carrier spacing information to the beamformer.

11. The system of claim 10, wherein the beamformee determines which sub-carrier spacing to transmit to the beamformer based on a cost function.

12. The system of claim 1, wherein the beamformer further computes at least one steering angle pair for at least one sub-carrier in the subset for which channel information is received.

13. The system of claim 1, wherein the beamformer interpolates over a subset of parameterized angle information.

14. The system of claim 1, wherein the beamformer interpolates by applying at least one from the group of: a polynomial function, a rational function, a spline-based function and a trigonometric interpolation function.

15. A method for beamforming, comprising:
receiving channel information for a subset of sub-carriers;
interpolating the channel information that includes sub-carrier spacing information for the subset of sub-carriers to obtain at least one Givens rotation angle for remaining sub-carriers which are not members of the subset; and
reconstructing missing steering matrices from the interpolated angles.

16. The method of claim 15, wherein the receiving further comprising receiving channel information comprising Givens rotation angles for the subset of sub-carriers.

17. The method of claim 15, wherein the receiving further comprises receiving channel information comprising steering matrices of the subset of sub-carriers.

18. The method of claim 15, wherein the receiving further comprises receiving channel information comprising an index that enables corresponding sub-carrier spacing information to be obtained from a look-up table, the corresponding sub-carrier spacing information to be used to compute at least one angle pair for at least one sub-carrier of the subset.

19. The method of claim 15, further comprising computing at least one steering angle pair for at least one sub-carrier in the subset for which channel information is received.

20. The method of claim 15, wherein the interpolating further comprises interpolating over a subset of parameterized angle information.

21. The method of claim 15, wherein the interpolating further comprises interpolating using at least one from the group of: a polynomial function, a rational function, a spline-based function and a trigonometric interpolation function.
